(19) United States
(12) Patent Application Publication
(10) Pub. No.: US 2023/0324279 A1
(43) Pub. Date: Oct. 12, 2023

(54) CORROSION DETECTION SYSTEM FOR USE WITH A PIPING SYSTEM

(71) Applicant: Crane ChemPharma & Energy Corp., The Woodlands, TX (US)

(72) Inventors: Raj Kishore Mishra, Sundergarh (IN); David Yanik, Asheville, NC (US); Ashutosh Singh, Pune (IN); Bradley Allen, Marion, NC (US)

(21) Appl. No.: 18/296,933

(22) Filed: Apr. 6, 2023

Related U.S. Application Data
(60) Provisional application No. 63/362,683, filed on Apr. 8, 2022.

(51) Int. Cl. G01N 17/04; F16L 55/00; G01N 17/02; G01N 17/00

(52) U.S. Cl. CPC G01N 17/04; F16L 55/00; F16L 2101/30; G01N 17/006; G01N 17/02

(57) ABSTRACT

A corrosion detection system includes a wire disposed in a groove extending circumferentially around an exterior surface of a pipe, the pipe comprising a pipe wall and a pipe liner that lines an inside surface of the pipe wall. The corrosion detection system also includes a sensor electrically coupled to the wire. The sensor is configured to generate a voltage in the wire, and detect a change in a property of the wire caused by exposure of the wire to a corrosive fluid that is present within the pipe but outside the pipe liner.

### CROSS-REFERENCE TO RELATED APPLICATION AND PRIORITY CLAIM

This application claims priority under 35 U.S.C. § 119(e) to U.S. Provisional Patent Application No. 63/362,683 filed on Apr. 8, 2022, which is hereby incorporated by reference in its entirety.

### TECHNICAL FIELD

The present disclosure relates generally to detecting and indicating corrosion in piping, and relates more particularly to systems for detecting and indicating corrosion in piping such as piping having non-metallic liners.

### BACKGROUND

Within certain industries it is common to use pipes lined with a nonmetallic material, such as a polymeric material, for conveying certain materials or media, particularly those that are highly corrosive or that might themselves be compromised by contact with the material of the pipe itself. The fluid or medium flowing through such a piping system may over time permeate the liner, and begin to be present at the interface of the liner and the material of which the pipe wall itself is made (typically metal).

### SUMMARY

This disclosure provides systems for detecting and indicating corrosion in piping such as piping having non-metallic liners.

In a first embodiment, a corrosion detection system includes a wire disposed in a groove extending circumferentially around an exterior surface of a pipe, the pipe comprising a pipe wall and a pipe liner that lines an inside surface of the pipe wall. The corrosion detection system also includes a sensor electrically coupled to the wire. The sensor is configured to generate a voltage in the wire, and detect a change in a property of the wire caused by exposure of the wire to a corrosive fluid that is present within the pipe but outside the pipe liner.

In a second embodiment, a piping system includes a pipe configured to convey one or more fluids. The piping system also includes a groove extending circumferentially around an exterior surface of the pipe. The piping system also includes a wire disposed within the groove. The piping system also includes a sensor electrically coupled to the wire. The sensor is configured to generate a voltage in the wire, and detect a change in a property of the wire caused by exposure of the wire to a corrosive fluid that is present within the pipe but outside the pipe liner.

Other technical features may be readily apparent to one skilled in the art from the following figures, descriptions, and claims.

### BRIEF DESCRIPTION OF THE DRAWINGS

FIGS. 1A through 1E illustrate multiple views of an example piping system that includes a corrosion detection system according to various embodiments of the present disclosure; and

FIG. 2 illustrates an example of a computing device that can be used with a corrosion detection system according to various embodiments of the present disclosure.

### DETAILED DESCRIPTION

The figures discussed below and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

For simplicity and clarity, some features and components are not explicitly shown in every figure, including those illustrated in connection with other figures. It will be understood that all features illustrated in the figures may be employed in any of the embodiments described. Omission of a feature or component from a particular figure is for purposes of simplicity and clarity and is not meant to imply that the feature or component cannot be employed in the embodiments described in connection with that figure.

As discussed above, it is common to use pipes lined with a nonmetallic material, such as a polymeric material, for conveying certain materials or media, particularly those that are highly corrosive or that might themselves be compromised by contact with the material of the pipe itself. The fluid or medium flowing through such a piping system or some fraction thereof may over time permeate the liner, and begin to be present at the interface of the liner and the material of which the pipe wall itself is made.

The permeation of media through a pipe liner is a recognized issue with fluoropolymer lined pipes, and national standards require venting of the metallic pipe wall to prevent buildup of permeant species between the liner outer diameter and the pipe inner diameter for some fluoropolymers. This can lead to several issues like reduced pressure bearing capability, pipe material loss, localized stress, pipe burst, etc., which can be dangerous as well as an economic concern. An important issue is the possibility of corrosion that is left undetected in plastic lined pipes, which may not raise alarm for any internal pipe damage but may eventually lead to catastrophic pipe failure. Another issue is the need for regular inspection and maintenance of plastic lined pipe, since any internal damage cannot be detected from the outer pipe surface. Conventional techniques for detecting corrosion before the pipe is fully damaged are destructive or not very effective as most of the techniques are only localized in application.

To address these and other issues, embodiments of the present disclosure provide a corrosion detection system for use with a lined pipe to detect and indicate when corrosion has occurred. The disclosed corrosion detection system includes one or more wires disposed in at least one groove that extend circumferentially around the exterior surface of the pipe.

It will be understood that embodiments of this disclosure may include any one, more than one, or all of the features described here. In addition, embodiments of this disclosure may additionally or alternatively include other features not listed here. Some of the following embodiments are described with respect to devices, systems, and processes for use with piping systems. However, such description is not limiting; it will be clear to those of skill in the art that the disclosed embodiments are also applicable in association with other types of devices, systems, and processes.

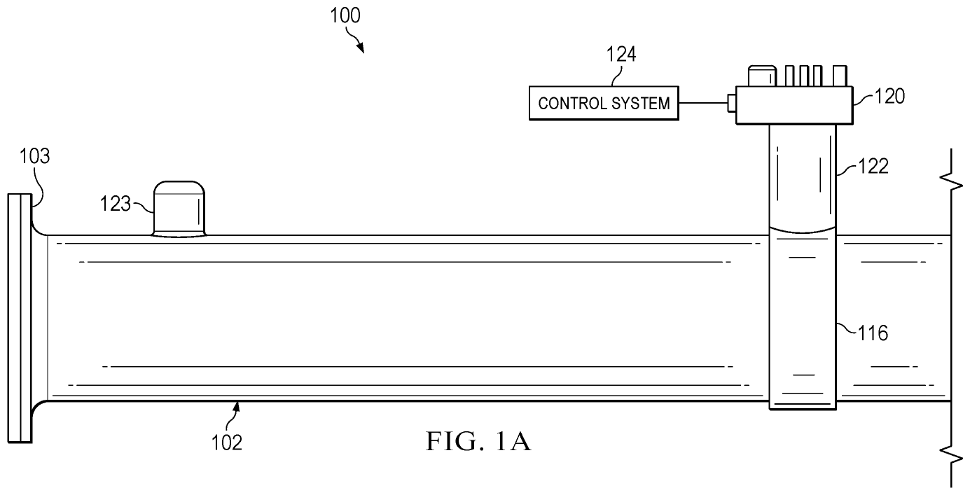

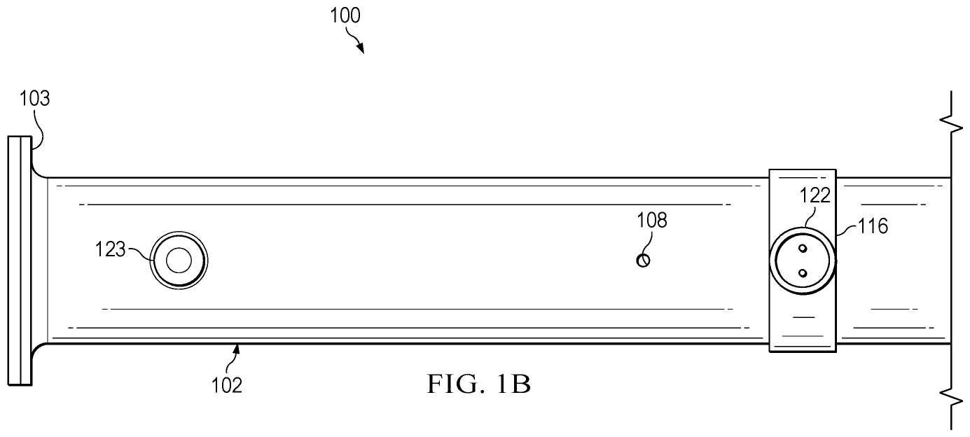

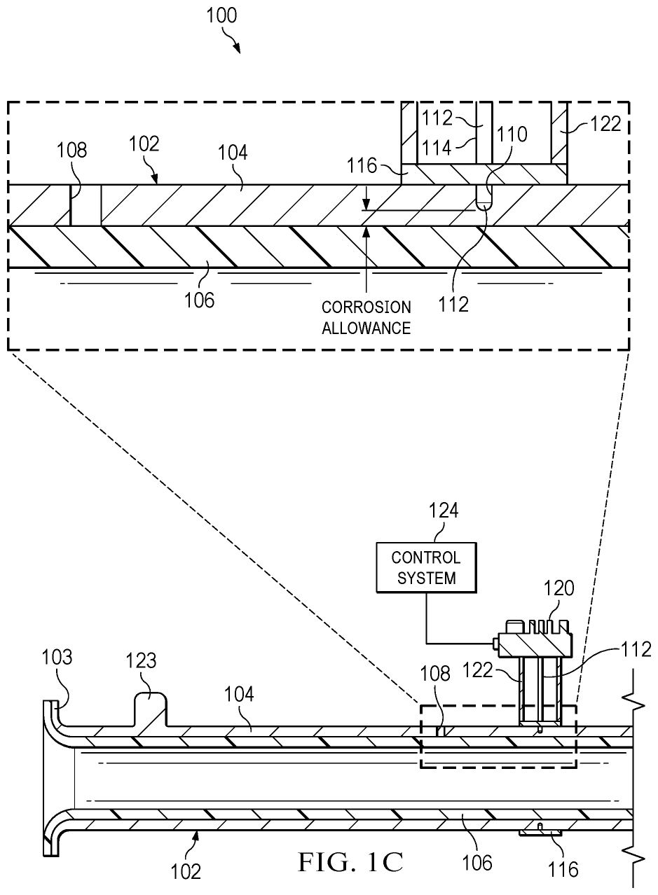

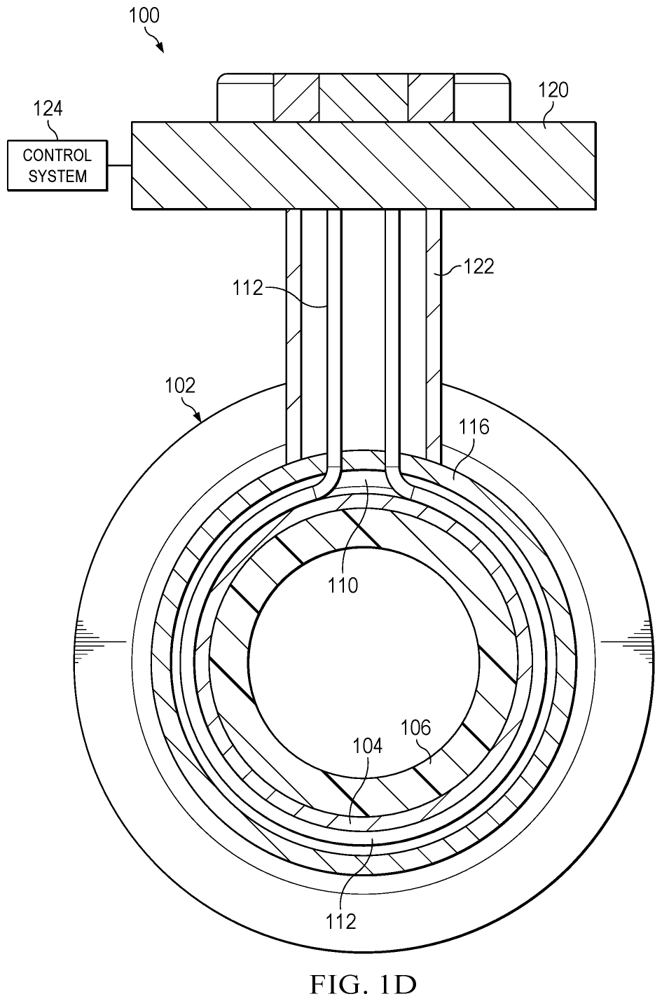

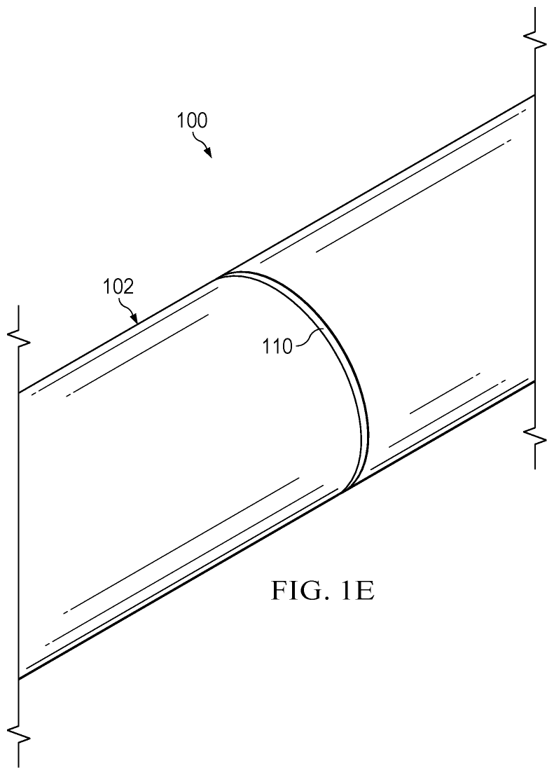

FIGS. 1A through 1E illustrate multiple views of an example piping system 100 that includes a corrosion detection system according to various embodiments of the present disclosure. In particular, FIG. 1A illustrates a side view of piping system 100, FIG. 1B illustrates a top view of the piping system 100, FIG. 1C illustrates longitudinal cross sectional views of portions of the piping system 100 at different scales, FIG. 1D illustrates a transverse cross sectional view of the piping system 100, and FIG. 1E illustrates a perspective view of portions of the piping system 100 with certain components not shown in order to better illustrate other components. The embodiment of the piping system 100 shown in FIGS. 1A through 1E is for illustration only. Other embodiments of the piping system 100 could be used without departing from the scope of this disclosure.

As shown in FIGS. 1A through 1E, the piping system 100 includes a metallic pipe 102 having a flanged end 103 and a pipe wall 104 formed of metal. The flanged end 103 is referred to a flared lap, and typically is used in conjunction with a rotatable lap joint flange (not shown), which is retained in its intended position by a projection 123. Standardized pipe ends have numerous options, including fixed welded flanges and others, all of which are within the scope of this disclosure. In some embodiments, the pipe wall 104 is formed of iron, steel, or copper-nickel, although other metals, metal alloys, or other materials are possible and within the scope of this disclosure. While the end 103 of the pipe 102 is shown as open, in many implementations, the end 103 is connected to another section of pipe, a valve, a pump, or another device or structure associated with a pipeline, using a flange (not shown). The inside of the pipe wall 104 is lined with a plastic or polymeric liner 106. In some embodiments, the liner 106 is formed of polytetrafluoroethylene (PTFE), polyvinylidene fluoride (PVDF), ethylene-tetrafluoroethylene (ETFE), or perfluoroalkoxy-alkane (PFA), although the liner 106 may be formed of other or additional materials. The liner 106 is provided to reduce the corrosive effects of the fluid conveyed within the pipe 102 or to protect the fluid from chemical interaction with the pipe 102.

A short distance (e.g., approximately four inches) in a longitudinal direction from the end 103 of the pipe 102 is a vent 108 that extends through the pipe wall 104, but does not extend through the pipe liner 106. In a typical installation, the pipe 102 is installed with the vent 108 facing downward. This allows liquid, which may have collected between the pipe wall 104 and the pipe liner 106, to drain out of the pipe 102. Because corrosive processes tend to progress most rapidly in proximity to the vent 108, as the corrosive elements can become more aggressive when exposed to atmospheric moisture, it can be advantageous to provide a corrosion detection system near the vent 108.

Accordingly, disposed a short distance (e.g., approximately 6-12 inches or less) in a longitudinal direction from the vent 108 is a groove 110 in the exterior surface of the pipe wall 104. The groove 110 is narrow (e.g., one-eighth inch wide or similar) and has a depth that is less than the thickness of the pipe wall 104. The groove 110 extends substantially or completely circumferentially around the pipe wall 104, thus forming a complete (or substantially complete) ring around the pipe wall 104, such as shown in FIGS. 1D and 1E.

As shown in FIG. 1C, the depth of the groove 110 corresponds to a corrosion allowance limit of the pipe 102. That is, a predetermined portion of the thickness of the pipe wall 104, measured from the interface between the pipe wall 104 and the liner 106, is permitted to be corroded. The thickness of this portion is referred to as the corrosion allowance, and the most internal surface of the groove 110 (i.e., the “bottom” of the groove 110) coincides with the corrosion allowance thickness. The corrosion allowance can be determined by the owner or user of the piping system, or may be set by code or regulation. For example, if the pipe 102 conveys a hazardous material (such as phosgene, hydrofluoric acid, chloroacetic acid, oleum, or the like), it may be desirable for the corrosion allowance to be small such that corrosion is detected at an early stage. Conversely, if the pipe 102 carries a non-toxic material (such as sea water), the corrosion allowance may be larger. In some embodiments, the corrosion allowance is approximately 30% of the thickness of the pipe wall 104, although other corrosion allowances are possible and within the scope of this disclosure.

Disposed within the groove 110, and at the most internal depth of the groove 110, is a corrosion detection wire 112. The wire 112 is formed of a metal, alloy, or other electrically conductive material. For example, in some embodiments, the wire 112 is formed of zinc. In some embodiments, the material(s) or alloy(s) comprising the wire 112 can be selected for sensitivity to different permeant species. The wire 112 can be coated with, or otherwise surrounded by, an electrically insulative sheathing 114. The insulative sheathing 114 may be selected to corrode quickly in the presence of the corrosive fluid that corrodes through the pipe wall 104. The insulative sheathing 114 may alternatively be selected to quickly absorb fluid that corrodes through the pipe wall 104, thereby exposing the wire 112 directly to the corrosive fluid. Here, the corrosive fluid to which the wire 112 or insulative sheathing 114 is exposed can be the fluid conveyed in the pipe 102, or a “different” fluid caused by fractionation of the corrosive fluid during permeation or chemical reaction with the metallic pipe wall 104, or chemical reaction with atmospheric or other fluids present incidentally. The wire 112 extends within the groove 110 completely (or substantially completely) around the circumference of the pipe wall 104, at the depth that corresponds to the corrosion allowance. In some embodiments, the wire 112 can consist of a single wire with a circular cross section. In other embodiments, the wire 112 can consist of multiple strands arranged, twisted, or braided together. In still other embodiments, the wire 112 can represent a thin strap that is much smaller in one cross-sectional dimension than in the other. In some embodiments, the wire 112 may be placed in tension by a spring (not shown), which will physically separate (trigger) a highly corroded wire 112, causing an abrupt increase in resistivity.

In some embodiments, a filler material occupies remaining portions of the groove 110 not occupied by the wire 112. For example, the filler material may be a plastic that is inserted into the groove 110 above the wire 112 after the wire 112 is inserted into the groove 110. In some embodiments, the filler material seals the wire 112 within the groove 110 and protects the wire 112 from exposure to external contaminants or other conditions external to the pipe 102.

The pipe 102 can also include a reinforcing sleeve 116 that is disposed around the pipe wall 104 and covers the groove 110. The reinforcing sleeve 116 is formed of a rigid material (e.g., steel) and acts as a stiffening member to reinforce the structural integrity of the pipe 102, which may be otherwise weakened by the presence of the groove 110. In some embodiments, the reinforcing sleeve 116 may have a width of, e.g., approximately 2-6 inches (i.e., 1-3 inches on either side of the groove 110) and a thickness of approximately one quarter inch. Of course, these dimensions are examples only; other dimensions are possible and within the scope of this disclosure.

The wire 112 is electrically coupled to a sensor 120 that is capable of measuring one or more properties of the wire 112. For example, as shown in FIG. 1D, the ends of the wire 112 may pass through small holes in the reinforcing sleeve 116 and be directly coupled to the sensor 120. In other embodiments, one or more lead wires may connect the wire 112 and the sensor 120. The sensor 120 may be configured to measure the resistivity of the wire 112, the amount of current passing through the wire 112, or any other property of the wire 112. In some embodiments, the sensor 120 can also provide a voltage source that generates the current in the wire 112. In some embodiments, the sensor 120 is physically connected to the pipe 102. For example, the sensor 120 may be coupled to a stand-off pipe 122 that is, in turn, coupled to the pipe 102. The sensor 120 represents any suitable sensing device(s), circuit element(s), or structure(s) for generating a current in the wire 112 and measuring properties of the wire 112.

In some embodiments, the sensor 120 is communicatively coupled to a control system 124. The control system 124 can receive information about the wire 112 from the sensor 120 and perform one or more operations in response to the information. For example, the sensor 120 can send information about corrosion affecting the wire 112 to the control system 124, and the control system 124 can generate a warning or alarm regarding the corrosion to notify an operator or other personnel. The control system 124 represents any suitable device(s) or system(s) capable of receiving information and performing an operation in response. In some embodiments, the control system 124 comprises a computing device, such as a desktop computer, laptop computer, smart phone, tablet, or the like. The control system 124 may be communicatively coupled to the sensor 120 via a wireless or wired connection. The sensor 120 and the control system 124 may be disposed in any suitable location. In some embodiments, the sensor 120, the control system 124, or both may be disposed at, in, on, or adjacent to the reinforcing sleeve 116.

In one aspect of operation, a low voltage (e.g., 12-24 volts or the like) is applied to the wire 112 (e.g., by the sensor 120), and one or more properties of the wire 112 (e.g., the resistivity, current flow, or the like) are regularly or continuously measured by the sensor 120. Over time, corrosive fluid in the pipe 102 permeate through the pipe liner 106 and begin to corrode the pipe wall 104. Once the corrosion of the pipe wall 104 exceeds the corrosion allowance thickness, the corrosive fluid can enter the groove 110 and start to corrode the wire 112 and its sheathing 114. The wire 112 and sheathing 114 are both sensitive to corrosion. That is, the sheathing 114 may quickly be consumed by the corrosive fluid, thereby exposing the wire 112 to the corrosive fluid. The wire 112 itself can quickly be affected by the presence of the corrosive fluid. For example, portions of the wire 112 may dissolve or otherwise chemically react with the corrosive fluid, thereby changing one or more properties (e.g., the resistivity, current flow, or the like) of the wire 112. In some embodiments, a complete cross section of the wire 112 can be consumed by the corrosive fluid, thereby increasing the resistivity of the wire 112 to that of an open circuit.

Once the wire 112 becomes affected by the corrosion process, the sensor 120 can detect the property change(s) of the wire 112. In response to detecting the property change(s) of the wire 112, the sensor 120 can transmit a signal, data, or other information to the control system 124, thereby informing the control system 124 of the property change(s) of the wire 112. In response, the control system 124 can generate a warning or alarm regarding corrosion to notify an operator or other personnel. For example, the control system 124 may output an audible alarm to a speaker, output a text or visual alarm message to a display screen, output a vibration or haptic alarm, or a combination of two or more of these. In some embodiments, the warning or alarm may request or instruct maintenance of the pipe 102 to address the corrosion.

Since the wire 112 is disposed circumferentially substantially or completely around the plastic lined pipe 102, the wire 112 can serve as an indicator of corrosion not only in a small, localized area, but at all points around the circumference of the pipe 102 near the vent 108. This is an improvement over conventional systems that detect corrosion incident only at a single point near the pipe vent and do not consider any corrosion that may occur at other areas near the vent. The disclosed system is also therefore more likely to detect the presence of corrosion somewhere in the pipe 102 earlier than conventional systems, which improves user safety by decreasing the likelihood of a pipe burst. Since the disclosed corrosion detection system can be always operational, there is no need to shut down the pipe 102 to check for corrosion.

In some embodiments, instead of being a single circumferential loop (or partial loop), the groove 110 and the wire 112 could form a helical coil that makes more than one loop around the circumference of the pipe 102. In some embodiments, the coil formed by the groove 110 and the wire 112 could extend along a predetermined longitudinal length of the pipe 102 (e.g., twelve inches or any other suitable length).

In some embodiments, multiple wires 112 can be installed in multiple grooves 110 at different longitudinal locations along the pipe 102 and at different depths corresponding to different corrosion amounts. Each wire 112 can be separately connected to the sensor 120. The use of multiple wires 112 at multiple groove depths in one pipe 102 allows a corrosion rate to be calculated over time, since wires 112 disposed deeper into the pipe wall 104 would likely be exposed to corrosive fluid inside the pipe 102 earlier than wires 112 closer to the exterior surface of the pipe 102. Using corrosion rate data collected over time, the control system 124 may be capable of establishing a standard corrosion chart for maintenance and operation.

Although FIGS. 1A through 1E illustrate one example of a piping system 100 that includes a corrosion detection system, various changes may be made to FIGS. 1A through 1E. For example, various components in FIGS. 1A through 1E could be combined, further subdivided, or omitted and additional components could be added according to particular needs.

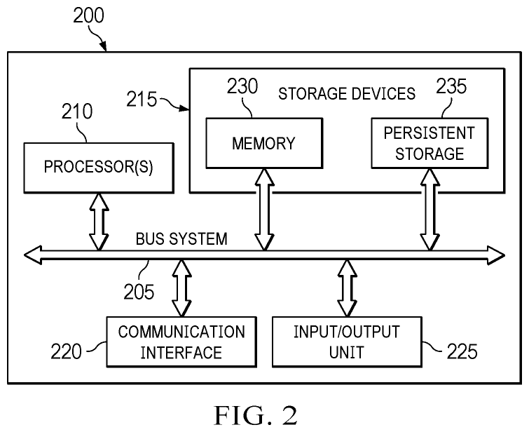

FIG. 2 illustrates an example of a computing device 200 that can be used with a corrosion detection system according to various embodiments of the present disclosure. In some embodiments, the computing device 200 (or portions thereof) may represent (or be represented by) the control system 124 or the sensor 120 (or portions thereof) discussed above in FIGS. 1A through 1E.

As shown in FIG. 2, the computing device 200 includes a bus system 205, which supports communication between processor(s) 210, storage devices 215, communication interface (or circuit) 220, and input/output (I/O) unit 225. The processor(s) 210 executes instructions that may be loaded into a memory 230. The processor(s) 210 may include any suitable number(s) and type(s) of processors or other devices in any suitable arrangement. Example types of processor(s) 210 include microprocessors, microcontrollers, digital signal processors, field programmable gate arrays, application specific integrated circuits, and discrete circuitry.

The memory 230 and a persistent storage 235 are examples of storage devices 215, which represent any structure(s) capable of storing and facilitating retrieval of information (such as data, program code, and/or other suitable information on a temporary or permanent basis). The memory 230 may represent a random access memory or any other suitable volatile or non-volatile storage device(s). The persistent storage 235 may contain one or more components or devices supporting longer-term storage of data, such as a read-only memory, hard drive, Flash memory, or optical disc. For example, persistent storage 235 may store one or more databases of data, standards data, results, data, client applications, etc.

The communication interface 220 supports communications with other systems or devices. For example, the communication interface 220 could include a network interface card or a wireless transceiver facilitating communications between the sensor 120 and the control system 124. The communication interface 220 may support communications through any suitable physical or wireless communication link(s). The I/O unit 225 allows for input and output of data. For example, the I/O unit 225 may provide a connection for user input through a keyboard, mouse, keypad, touchscreen, or other suitable input devices. The I/O unit 225 may also send output to a display, printer, or other suitable output devices.

Although FIG. 2 illustrates one example of a computing device 200, various changes may be made to FIG. 2. For example, various components in FIG. 2 could be combined, further subdivided, or omitted and additional components could be added according to particular needs. As a particular example, while depicted as one system, the computing device 200 may include multiple computing systems that may be remotely located.

In a first embodiment, a corrosion detection system includes a wire disposed in a groove extending circumferentially around an exterior surface of a pipe. The corrosion detection system also includes a sensor electrically coupled to the wire. The sensor is configured to generate a voltage in the wire, and detect a change in a property of the wire caused by exposure of the wire to a corrosive fluid conveyed within the pipe.

In one example of the first embodiment, the wire is disposed within the groove at a depth that corresponds to a corrosion allowance limit of the pipe.

In another example of the first embodiment, the corrosion allowance limit is measured from an interface between a pipe wall of the pipe and a pipe liner that lines an inside surface of the pipe wall.

In another example of the first embodiment, the pipe wall is formed of metal and the pipe liner is formed of a polymeric material.

In another example of the first embodiment, the groove is disposed less than twelve inches in a longitudinal direction from a vent that extends through a pipe wall of the pipe.

In another example of the first embodiment, the corrosion detection system also includes a control system communicatively coupled to the sensor. The sensor is configured, responsive to detecting the change in the property of the wire, to transmit a signal to the control system. The control system is configured, responsive to receiving the signal from the sensor, to generate a warning or alarm indicating regarding corrosion.

In another example of the first embodiment, the change in the property of the wire comprises a change in at least one of resistivity or current flow of the wire.

In another example of the first embodiment, the wire is surrounded by an electrically insulative sheathing configured to corrode with exposed to the corrosive fluid.

In another example of the first embodiment, the groove forms a helical coil that makes more than one circumferential loop around the exterior surface of the pipe.

In another example of the first embodiment, the corrosion detection system includes a second wire disposed in a second groove extending circumferentially around the exterior surface of the pipe, the second wire electrically coupled to the sensor.

In a second embodiment, a piping system includes a pipe configured to convey a corrosive fluid. The piping system also includes a groove extending circumferentially around an exterior surface of the pipe. The piping system also includes a wire disposed within the groove. The piping system also includes a sensor electrically coupled to the wire. The sensor is configured to generate a voltage in the wire, and detect a change in a property of the wire caused by exposure of the wire to the corrosive fluid.

In one example of the second embodiment, the wire is disposed within the groove at a depth that corresponds to a corrosion allowance limit of the pipe.

In another example of the second embodiment, the corrosion allowance limit is measured from an interface between a pipe wall of the pipe and a pipe liner that lines an inside surface of the pipe wall.

In another example of the second embodiment, the pipe wall is formed of metal and the pipe liner is formed of a polymeric material.

In another example of the second embodiment, the groove is disposed less than twelve inches in a longitudinal direction from a vent that extends through a pipe wall of the pipe.

In another example of the second embodiment, the corrosion detection system also includes a control system communicatively coupled to the sensor. The sensor is configured, responsive to detecting the change in the property of the wire, to transmit a signal to the control system. The control system is configured, responsive to receiving the signal from the sensor, to generate a warning or alarm indicating regarding corrosion.

In another example of the second embodiment, the change in the property of the wire comprises a change in at least one of resistivity or current flow of the wire.

In another example of the second embodiment, the wire is surrounded by an electrically insulative sheathing configured to corrode with exposed to the corrosive fluid.

In another example of the second embodiment, the groove forms a helical coil that makes more than one circumferential loop around the exterior surface of the pipe.

In another example of the second embodiment, the piping system includes a reinforcing sleeve disposed around the exterior surface of the pipe and covering the groove, the reinforcing sleeve formed of a rigid material and provided to reinforce a structural integrity of the pipe.

It may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The phrase “such as,” when used among terms, means that the latter recited term(s) is(are) example(s) and not limitation(s) of the earlier recited term. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described herein can be implemented or supported by one or more computer programs, each of which is formed from computer readable program code and embodied in a computer-readable medium. The terms “application” and “program” refer to one or more computer programs, software components, sets of instructions, procedures, functions, objects, classes, instances, related data, or a portion thereof adapted for implementation in a suitable computer readable program code. The phrase “computer-readable program code” includes any type of computer code, including source code, object code, and executable code. The phrase “computer-readable medium” includes any type of medium capable of being accessed by a computer, such as read-only memory (ROM), random access memory (RAM), a hard disk drive, a compact disc (CD), a digital video disc (DVD), or any other type of memory. A “non-transitory” computer-readable medium excludes wired, wireless, optical, or other communication links that transport transitory electrical or other signals. A non-transitory, computer-readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases. Although the present disclosure has been described with an exemplary embodiment, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claim scope. The scope of the patented subject matter is defined by the claims.

What is claimed is:

1. A corrosion detection system, comprising:
a wire disposed in a groove extending circumferentially around an exterior surface of a pipe, the pipe comprising a pipe wall and a pipe liner that lines an inside surface of the pipe wall;
a sensor electrically coupled to the wire, the sensor configured to:
generate a voltage in the wire; and
detect a change in a property of the wire caused by exposure of the wire to a corrosive fluid that is present within the pipe but outside the pipe liner.

2. The corrosion detection system of claim 1, wherein the wire is disposed within the groove at a depth that corresponds to a corrosion allowance limit of the pipe.

3. The corrosion detection system of claim 2, wherein the corrosion allowance limit is measured from an interface between the pipe wall and the pipe liner.

4. The corrosion detection system of claim 1, wherein the pipe wall is formed of metal and the pipe liner is formed of a polymeric material.

5. The corrosion detection system of claim 1, wherein the groove is disposed less than twelve inches in a longitudinal direction from a vent that extends through the pipe wall.

6. The corrosion detection system of claim 1, further comprising:
a control system communicatively coupled to the sensor,
wherein the sensor is configured, responsive to detecting the change in the property of the wire, to transmit a signal to the control system, and
wherein the control system is configured, responsive to receiving the signal from the sensor, to generate a warning or alarm indicating regarding corrosion.

7. The corrosion detection system of claim 1, wherein the change in the property of the wire comprises a change in at least one of resistivity or current flow of the wire.

8. The corrosion detection system of claim 1, wherein the wire is surrounded by an electrically insulative sheathing configured to corrode when exposed to the corrosive fluid or to absorb the corrosive fluid.

9. The corrosion detection system of claim 1, wherein the groove forms a helical coil that makes more than one circumferential loop around the exterior surface of the pipe.

10. The corrosion detection system of claim 1, further comprising:
a second wire disposed in a second groove extending circumferentially around the exterior surface of the pipe, the second wire electrically coupled to the sensor.

11. A piping system, comprising:
a pipe configured to convey one or more fluids, the pipe comprising a pipe wall and a pipe liner that lines an inside surface of the pipe wall;
a groove extending circumferentially around an exterior surface of the pipe;
a wire disposed within the groove; and
a sensor electrically coupled to the wire, the sensor configured to:
generate a voltage in the wire; and
detect a change in a property of the wire caused by exposure of the wire to a corrosive fluid that is present within the pipe but outside the pipe liner.

12. The piping system of claim 11, wherein the wire is disposed within the groove at a depth that corresponds to a corrosion allowance limit of the pipe.

13. The piping system of claim 12, wherein the corrosion allowance limit is measured from an interface between the pipe wall and the pipe liner.

14. The piping system of claim 11, wherein the pipe wall is formed of metal and the pipe liner is formed of a polymeric material.

15. The piping system of claim 11, wherein the groove is disposed less than twelve inches in a longitudinal direction from a vent that extends through the pipe wall.

16. The piping system of claim 11, further comprising:
a control system communicatively coupled to the sensor,
wherein the sensor is configured, responsive to detecting the change in the property of the wire, to transmit a signal to the control system, and
wherein the control system is configured, responsive to receiving the signal from the sensor, to generate a warning or alarm indicating regarding corrosion.

17. The piping system of claim 11, wherein the change in the property of the wire comprises a change in at least one of resistivity or current flow of the wire.

18. The piping system of claim 11, wherein the wire is surrounded by an electrically insulative sheathing configured to corrode with exposed to the corrosive fluid or to absorb the corrosive fluid.

19. The piping system of claim 11, wherein the groove forms a helical coil that makes more than one circumferential loop around the exterior surface of the pipe.

20. The piping system of claim 11, further comprising:
a reinforcing sleeve disposed around the exterior surface of the pipe and covering the groove, the reinforcing sleeve formed of a rigid material and provided to reinforce a structural integrity of the pipe.
